(19) United States
(12) Patent Application Publication
(10) Pub. No.: US 2024/0123905 A1
(43) Pub. Date: Apr. 18, 2024

(54) DISPLAY SYSTEM, VEHICLE, CONTROL METHOD, AND STORAGE MEDIUM

(71) Applicant: CANON KABUSHIKI KAISHA, Tokyo (JP)

(72) Inventor: YOSHINOBU IIDA, Tokyo (JP)

(21) Appl. No.: 18/376,515

(22) Filed: Oct. 4, 2023

(30) Foreign Application Priority Data
Oct. 12, 2022 (JP) 2022-163774

(51) Int. Cl. B60R 1/25; H04N 7/18; H04N 23/90

(52) U.S. Cl. CPC B60R 1/25; H04N 7/181; H04N 23/90; G06V 20/58

(57) ABSTRACT

A display system comprising a opposite lane side camera that is disposed on an opposite lane side of a vehicle and capable of capturing at least a forward direction of the vehicle and a monitor control unit configured to cause a monitor to display an image in at least the forward direction captured by the opposite lane side camera in an opposite lane side turn ready state of the vehicle.

### BACKGROUND OF THE INVENTION

### Field of the Invention

The present invention relates to a display system for displaying the surroundings of a vehicle, the vehicle, a control method, and a storage medium.

### Description of the Related Art

A driver has to pay attention to many things when turning right or left. In particular, an intersection with poor visibility and an intersection with heavy traffic are more dangerous. Additionally, there is a problem in which an object to which attention should be paid changes every moment during a right or left turn.

As means for solving the above-described problem, Japanese Patent Application Laid-Open No. 2019-186853 proposes a driving support system for avoiding a collision with a vehicle or a pedestrian coming from the backward direction on the right and left sides, by displaying an image in the backward direction on the right side and an image in the backward direction on the left side on electronic side mirrors in a right/left turn directions during a right/left turn.

However, during a right turn on left-hand traffic, there are a scene of waiting for a right turn in which the presence or absence of a vehicle traveling straight from an opposite lane is confirmed around an intersection, and a scene in the middle of a right turn in which it is determined that there is no vehicle traveling straight, the right turn is started, a pedestrian is confirmed in front of a crosswalk, and the right turn is completed.

Then, in the scene of waiting for a right turn, it is necessary to confirm a vehicle traveling straight in the opposite lane. Additionally, in a scene in the middle of a right turn, in order to confirm the presence or absence of a pedestrian on the crosswalk, it is necessary to confirm the forward direction and the lateral direction according to the positional relation between the vehicle and the crosswalk.

Similarly, during a left turn, there are a scene of waiting for a left turn in which it is confirmed whether or not a motorbike, a bicycle, and the like are involved near an intersection, whether a right turn vehicle on an opposite lane turns ahead, and the like, and a scene in the middle of a left turn in which a left turn is started, a pedestrian is confirmed in front of a crosswalk, and the left turn is completed.

In the scene of waiting for a left turn, it is necessary to pay sufficient attention to the involvement of a motorcycle, a bicycle, or the like by visual check, and in addition, it is necessary to confirm whether or not a right turn vehicle in the opposite lane turns ahead. Additionally, in a scene in the middle of a left turn, it is also necessary to confirm the presence or absence of a pedestrian on a crosswalk.

However, in Japanese Patent Application Laid-Open No. 2019-186853, since only the image in the backward direction on the side opposite to the right or left turn direction is displayed, it is not possible to support driving against a vehicle, a pedestrian, or other dangers from the forward direction on the side opposite to the right or left turn direction. Furthermore, there is a problem in that it is not possible to perform optimal display for each scene of a right or left turn.

### SUMMARY OF THE INVENTION

A display system in one aspect of the present invention comprising
a opposite lane side camera that is disposed on an opposite lane side of a vehicle and capable of capturing at least a forward direction of the vehicle; and
at least one processor or circuit configured to function as:
a monitor control unit configured to cause a monitor to display an image in at least the forward direction captured by the opposite lane side camera in an opposite lane side turn ready state of the vehicle.

Further features of the present invention will become apparent from the following description of embodiments with reference to the attached drawings.

### BRIEF DESCRIPTION OF THE DRAWINGS

FIG. 1 is a functional block diagram showing a configuration example of a display system 100 according to the embodiment of the present invention.

FIG. 2 is a diagram showing a layout example of a right-side camera 12 mounted on the vehicle in the embodiment of the present invention.

FIG. 3 is a flowchart illustrating an example of a control method of the display system 100 according to the embodiment of the present invention.

FIG. 4 is a diagram showing a display example of a right monitor 14 and a left monitor 15 during normal traveling in the embodiment of the present invention.

FIG. 5 is a diagram showing a display example of the right monitor 14 while waiting for a right turn in the embodiment of the present invention.

FIG. 6 is a diagram showing an example of an image displayed on the right monitor 14 in the middle of a right turn in the embodiment of the present invention.

FIG. 7 is a flowchart showing an example of a process flow during a left turn executed by the display system 100 in the embodiment of the present invention.

FIG. 8 is a diagram showing an example of an image of an opposite lane displayed in the second display region D2 of the right monitor 14 while waiting for a left turn in the embodiment of the present invention.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified. Hereinafter, Embodiment is explained based on rules of left-hand traffic, however, Embodiment can be applied to a system that is based on rules of right-hand traffic. That is, right and left in turns, monitor arrangements, and camera arrangements in the following Embodiment based on rules of left-hand traffic should respectively read as left and right in turns, monitor arrangements, and camera arrangements in a system based on rules of right-hand traffic.

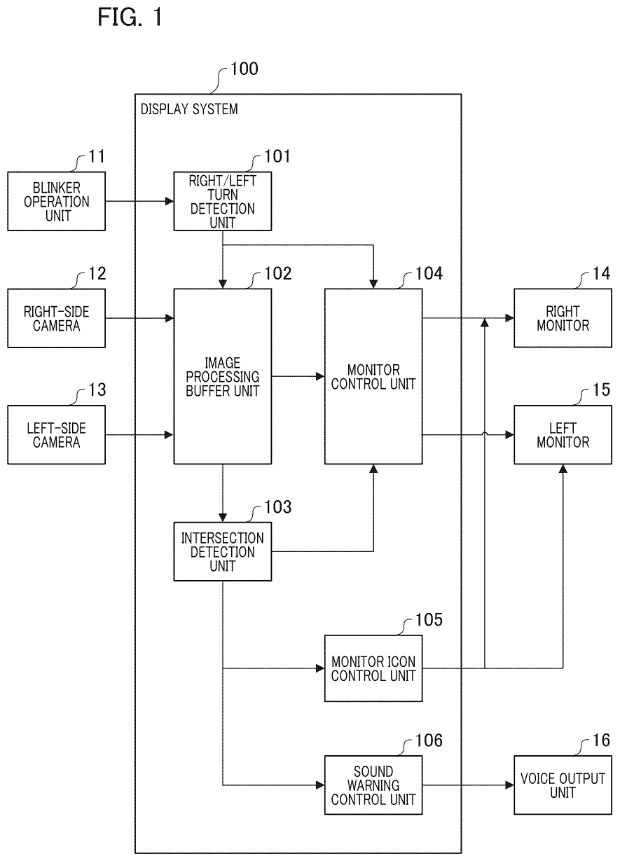

FIG. 1 is a functional block diagram illustrating a configuration example of a display system 100 according to the embodiment of the present invention. Note that some of the functional blocks shown in FIG. 1 are realized by a computer (not illustrated) included in the display system 100 executing a computer program stored in a memory serving as a storage medium (not illustrated).

However, a part or all of them may be realized by hardware. As the hardware, a dedicated circuit (ASIC), a processor (reconfigurable processor, DSP), and the like can be used. Additionally, each of the functional blocks shown in FIG. 1 may not necessarily be incorporated in the same housing and may be configured by separate devices connected to each other via a signal path.

In FIG. 1, a signal from a blinker operation unit 11 is sent to a right/left turn detection unit 101, and whether this is a right or left turn is determined in the right/left turn detection unit 101. Here, a left turn means a turn toward a non-opposite lane side, which is a traveling lane side, and a right turn means a turn toward an opposite lane side, which is a non-traveling lane side. Additionally, image information from a right-side camera 12 and a left-side camera 13 is temporarily stored in an image processing buffer unit 102. Here, the right-side camera 12 is an opposite lane side camera which is disposed on an opposite lane side of a center of vehicle, and the left-side camera 13 is a traveling lane side camera or a non-opposite lane side camera which is disposed on a non-opposite lane side of a center of vehicle.

Here, each of the right-side camera 12 and the left-side camera 13 has an optical system and an imaging element (not illustrated), and is installed so as to be able to capture image information around a car 2, at least the forward direction of the car 2.

An optical image of an object formed on a light receiving surface of the imaging element by the optical system is converted into an image signal by the imaging element, and analog/digital conversion, image adjustment processing, and the like are performed to generate image data. It suffices if the imaging element is an image sensor, for example, a CCD and a CMOS.

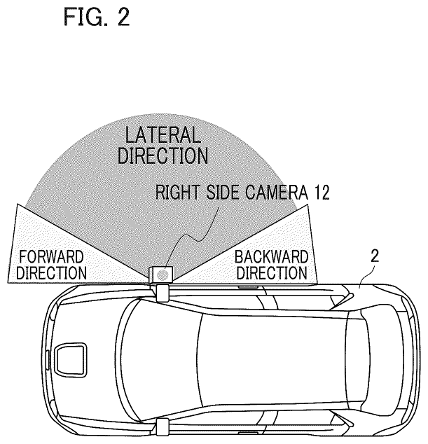

FIG. 2 is a view showing a layout example of the right-side camera 12 mounted on a vehicle in the embodiment of the present invention, and the right-side camera 12 is arranged on the right-forward direction (or the right side) of the vehicle 2. Additionally, in the right-side camera 12, a camera using an optical system capable of achieving high resolution (low distortion) in the peripheral portion of the imaging angle of view corresponding to the forward direction and the backward direction of the vehicle 2 is used.

That is, the right-side camera has an optical system and an imaging element, and can image at least the forward direction of the vehicle 2. Additionally, the optical system of the present embodiment has a characteristic of low resolution (high distortion) with respect to the imaging angle of view in the lateral direction in FIG. 2.

By using such a camera, an image in the backward direction as shown in FIG. 2 becomes a high-resolution image with the same angle of view as the right-side mirror. Additionally, the image in the forward direction as shown in FIG. 2 is also a high-resolution image. Note that the details of the optical system will be described below.

Although the image in the lateral direction as shown in FIG. 2 has a low resolution (high distortion), the image can be used as a side-view image that is wide in the lateral direction of the vehicle 2 by applying distortion correction processing. Although not illustrated, similarly to the right-side camera 12, in the left-side camera 13, an optical system in which the imaging angle of view of the camera corresponding to the forward direction and the backward direction of the vehicle 2 is high resolution (low distortion) is used.

Note that, when the focal length of the optical system is f, the half angle of view is θ, the image height on the image plane is y, the projection characteristic representing the relation between the image height y and the half angle of view θ is y (θ), and θ max is the maximum half angle of view of the optical system, the optical system used in the present embodiment satisfies, for example, the condition of Formula 1 below.

0.2<2×f×tan(θ max/2)/y(θ max)<0.92 [Formula 1]

In the optical system satisfying the condition of Formula 1, a region on the center side of the light receiving surface of the imaging element is a low resolution region (high distortion region), and a region on the peripheral side of the light receiving surface in which the half angle of view θ is equal to or larger than the predetermined half angle of view θa is a high resolution region (low distortion region). That is, the optical system of the present embodiment forms a high-resolution region in the peripheral portion of the light receiving surface, and forms a low-resolution region in the central portion of the light receiving surface.

The image information stored in the image processing buffer unit 102 is output to an intersection detection unit 103 and a monitor control unit 104, based on the information on the right turn or the left turn from the right/left turn detection unit 101. Furthermore, the intersection detection unit 103 detects whether or not the vehicle has approached an intersection and whether or not a crosswalk is present based on the image information from the image processing buffer unit 102, and also detects whether or not there is a pedestrian, a bicycle, and the like around the crosswalk by using image recognition.

Then, information on the presence or absence of a crosswalk is output to the monitor control unit 104. In contrast, information on whether or not a moving object, for example, a pedestrian and a bicycle is present around the crosswalk is also output to a monitor icon control unit 105 and a sound warning control unit 106.

The monitor control unit 104 controls an image to be output to the right monitor 14 or the left monitor 15 serving as a display unit based on information on whether the turn is a right turn or a left turn from the right/left turn detection unit 101 and information on whether or not the vehicle has approached to an intersection from the intersection detection unit 103. That is, the monitor control unit 104 performs control on whether any of the images in the forward, lateral, and backward directions from the image processing buffer unit 102 is output to the right monitor 14 or the left monitor 15.

Additionally, the monitor icon control unit 105 controls the display of an icon indicating the presence of a moving object on the right monitor 14 or the left monitor 15 based on information from the intersection detection unit 103 as to whether or not a moving object, for example, a pedestrian and a bicycle is present in the vicinity of the crosswalk. Additionally, a sound warning control unit 106 controls a voice output unit 16 to output a warning sound indicating the presence of a moving object based on the information from the intersection detection unit 103 as to whether or not a pedestrian, a bicycle, and the like are present around the crosswalk.

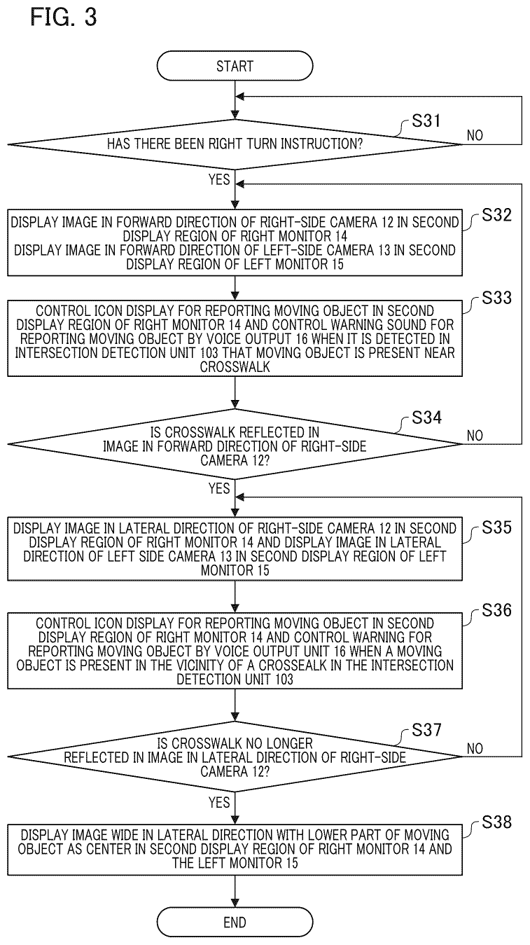

Here, an example of the display system 100 of the present embodiment during a right turn will be described with reference to the flowchart of FIG. 3. FIG. 3 is a flowchart showing an example of a control method of the display system 100 according to the embodiment of the present invention, and shows an example of a processing flow during a right turn.

Note that the CPU serving as a computer in the display system 100 executes a computer program stored in the memory, thereby performing the operation of each step in the flowchart of FIG. 3.

When the flow of FIG. 3 starts, images are displayed on the right monitor 14 and the left monitor 15. Note that the right monitor 14 and the left monitor 15 are respectively disposed on the right and left inside the vehicle 2. However, if the waterproof function is high, the right monitor 14 and the left monitor 15 may respectively be disposed on the right and left outside the vehicle 2. Although, in the present embodiment, the right monitor and the left monitor are provided independently, one shared monitor may be provided.

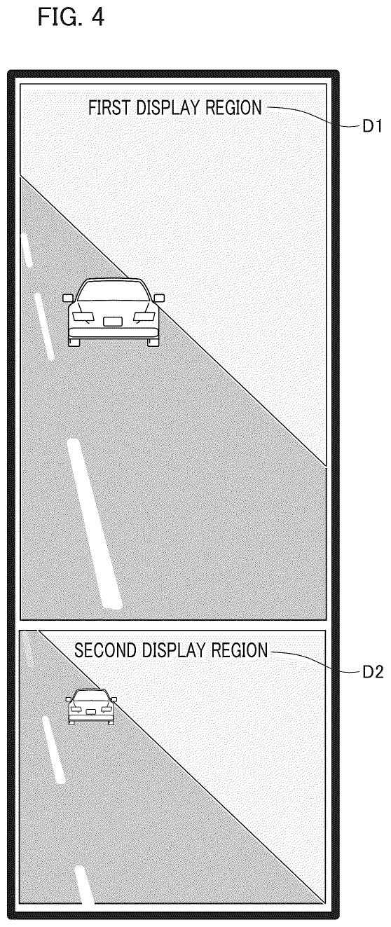

FIG. 4 is a diagram showing a display example of the right monitor 14 and the left monitor 15 during normal traveling in the embodiment of the present invention. As shown in FIG. 4, the display unit is configured by, for example, a liquid crystal monitor, and the display screen is divided into two, that is, upper and lower parts. In a first display region D1 on the upper side of the display screen, an image having an angle of view similar to that of an optical side mirror (for example, an angle of view including a lane in the diagonally backward direction) is always displayed in a large size in a power-on state.

In contrast, in a second display region D2 on the lower side of the display screen, a small image in a diagonally backward direction that is wide in the lateral direction with the lower part of the vehicle as the center is displayed. Note that, although the display screens of the right monitor 14 and the left monitor 15 are vertically divided into two as shown in FIG. 4, the display screens do not necessarily have to be divided, or may be divided into three or more.

Next, in step S31, the CPU of the display system 100 determines whether or not a right turn instruction has been issued. If “NO” is determined in step S31, the process returns to step S31. When the driver tilts the blinker to the right using the blinker operation unit 11, the right/left turn detection unit 101 detects that a right turn instruction has been issued (the state shifts to a right turn ready state), and the process proceeds to step S32.

Note that, in the present embodiment, the right turn ready state is determined based on the operation of the right blinker of the vehicle 2, and the left turn ready state is determined based on the operation of the left blinker of the vehicle 2. Additionally, the right turn ready state corresponds to a right turn waiting state and the left turn ready state corresponds to a left turn waiting state.

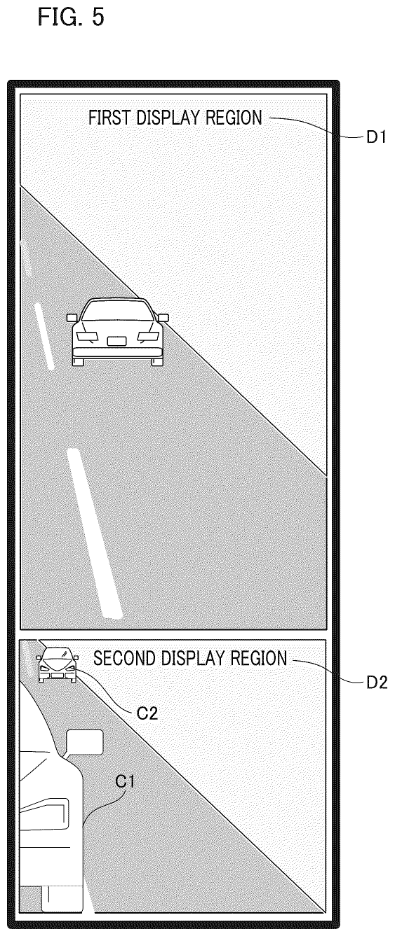

In step S32, the CPU of the display system 100 displays an image in the forward direction captured by the right-side camera 12 in the second display region of the right monitor 14, as shown in FIG. 5. Note that, at this time, the display content of the first display region D1 of the right monitor 14 and the left monitor 15 is the same as the content of the first display region D1 in FIG. 4, and is an image in the diagonally backward direction of the car 2.

FIG. 5 is a diagram showing a display example of the right monitor 14 when the vehicle is waiting for a right turn in the embodiment of the present invention, and an image of an opposite lane in the forward direction is displayed in the second display region D2 of the right monitor 14. At this time, although not illustrated, an image in the forward direction of the left-side camera 13 is displayed in the second display region D2 of the left monitor 15.

Here, the step S32 functions as a monitor control step (monitor control unit) of displaying an image in at least the forward direction captured by the right-side camera on the monitor (right monitor) in a right turn ready state of the vehicle. Note that, in the present embodiment, the image in the forward direction is an image corresponding to a high-resolution region, and thus, the image has high visibility for the user.

That is, at this time, in the second display region D2 in FIG. 5, a vehicle C1 waiting for a right turn in the opposite lane and a straight-traveling vehicle C2 in the opposite lane further on the right side are displayed. Immediately after issuing a right turn blinker, the vehicle stops near the intersection, and the driver confirms the presence or absence of the straight-traveling vehicle C2 coming from the opposite lane.

Accordingly, as described above, in the second display region D2 of the right-side camera 12, the vehicle C1 waiting for a right turn in the opposite lane are largely reflected on the near side, and the straight-traveling vehicle C2 is reflected on the far side, as shown in FIG. 5.

Here, when the straight-traveling vehicle C2 is far away or the road is curved, the straight-traveling vehicle C2, as viewed from the driver's seat, enters the blind spot of the vehicle C1 waiting for a right turn in the opposite lane, and in many cases, the straight-traveling vehicle C2 is not visible unless it approaches the intersection for some distance and the vehicle starts a right turn.

In contrast, in the present embodiment, since the straight-traveling vehicle C2 is less likely to enter the blind spot of the vehicle C1 waiting for a right turn in the opposite lane in the image in the forward direction captured by the right-side camera 12, the driver can more quickly notice that the straight-traveling vehicle C2 is approaching. Note that when image recognition is obtained that the straight-traveling vehicle C2 is rapidly approaching at a speed equal to or higher than a predetermined speed, a warning display may be displayed on the screen, or a voice warning may be issued by the voice output unit 16.

Next, in step S33, the CPU of the display system 100 detects whether or not a moving object is present in the vicinity of the crosswalk in the intersection detection unit 103. Since the vehicle 2 stops near the intersection, the image in the lateral direction captured by the right-side camera 12 is acquired from the image processing buffer unit 102.

When a region where white lines are intermittently drawn to indicate a crosswalk on the road and pedestrian traffic signal lights are recognized in the acquired image, the crosswalk is recognized and whether or not a moving object is reflected around the crosswalk is detected.

Here, the moving object is an automobile, a bicycle, a pedestrian, and the like. When the moving object is detected, the monitor icon control unit 105 performs control to display an icon informing about the presence of the moving object around the crosswalk in the second display region of the right monitor 14. Additionally, the sound warning control unit 106 performs control to cause the voice output unit 16 to output a warning sound informing about the presence of a moving object around the crosswalk.

Note that the voice output unit 16 may be any device that emits sound in the automobile, and, for example, a voice output function of a car navigation system may be used. By notifying the driver of the presence of a moving object around the crosswalk as described above, it is possible to inform the driver that he or she is still unable to turn right, even when the straight-traveling vehicle C2 is not present. As a result, it is possible to prevent an accident, for example, in the vicinity of a crosswalk on the front side during start of a right turn.

As described above, the monitor icon provides notification about unit 105 and the sound warning control unit function as notification units that informs a predetermined icon and a sound warning when a moving object and the like are detected based on an image. After the end of step S33, or when no moving object is detected around the crosswalk in step S33, the process proceeds to the next step S34.

In step S34, the CPU of the display system 100 detects, in the intersection detection unit 103, whether or not the crosswalk is reflected in the image in the forward direction captured by the right-side camera 12. When the driver determines that the vehicle can turn right and starts to turn right, the traveling direction of the vehicle changes and the crosswalk is reflected in the image in the forward direction captured by the right-side camera 12.

Specifically, the image in the forward direction captured by the right-side camera 12 is acquired from the image processing buffer unit 102, and the fact that the crosswalk is reflected (the crosswalk image is recognized) is detected by the above-described method. In the case in which the crosswalk is not reflected in the image in the forward direction (the crosswalk image is not recognized), the process returns to step S32.

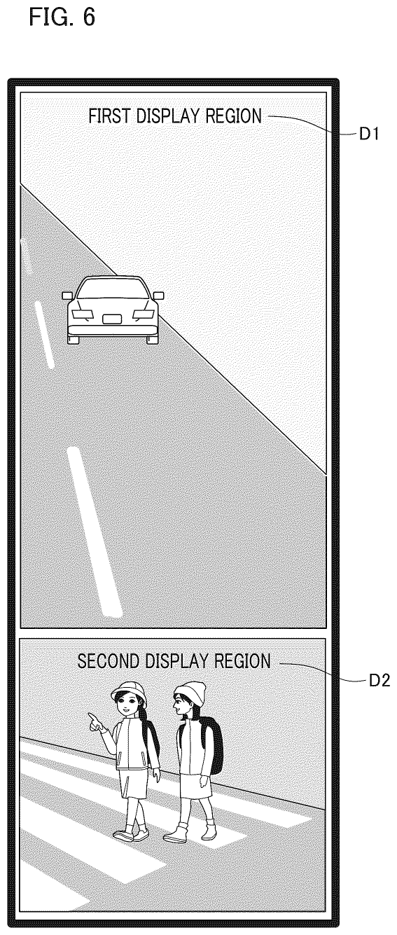

In contrast, when it is detected in step S34 that the crosswalk is detected (reflected) in the image in the forward direction, in step S35, the CPU of the display system 100 performs display as shown in FIG. 6. FIG. 6 is a diagram showing an example of an image displayed on the right monitor 14 during a right turn in the embodiment of the present invention, and an image in the lateral direction captured by the right-side camera 12 (an image around a crosswalk) is displayed in the second display region D2 of the right monitor 14.

That is, when the vehicle 2 starts to turn right and the crosswalk is detected, the image in the lateral direction of the vehicle 2 captured by at least the right-side camera is displayed on the monitor. At this time, the display content of the first display region D is an image in the diagonally backward direction of the vehicle 2, which is similar to the display content of the first display region D in FIG. 4.

Although not illustrated, an image in the lateral direction of the left-side camera 13 is displayed in the second display region D2 of the left monitor 15. Note that the image that is displayed in the second display region D2 in FIG. 6 is an example of an image when the vehicle is in the vicinity in front of a crosswalk. It is possible to easily and reliably confirm whether or not a moving object is present on the crosswalk by performing such a display.

That is, in the case of a right turn, a moving object coming from the left side of the crosswalk when viewed from the vehicle 2 is on the driver's line of sight, so the driver can visually confirm the moving object. In contrast, as shown in the image displayed in the second display region D2 in FIG. 6, a moving object coming from the right side of the crosswalk when viewed from the vehicle 2 deviates from the line of sight, resulting in a delay in noticing.

Accordingly, an accident around a crosswalk when the vehicle turns right can be prevented by displaying a moving object that is near the area where the driver's visual confirmation is delayed in the second display region D2 of the right monitor 14.

Next, in step S36, as in step S33, when a moving object is present near the crosswalk, the CPU of the display system 100 notifies the driver of the presence of the moving object by displaying an icon or emitting a warning sound. As a result, it is possible to prevent an accident more reliably around the crosswalk during a right turn. In step S37, the CPU of the display system 100 determines, in the intersection detection unit 103, whether or not the crosswalk is no longer reflected in the image in the lateral direction captured by the right-side camera 12.

Specifically, the image in the lateral direction captured by the right-side camera 12 is obtained from the image processing buffer unit 102, and it is detected whether or not the crosswalk is not reflected by the above-described method. While the crosswalk is reflected in the image in the lateral direction, the process returns to step S35, and the current display is maintained.

In contrast, when the driver determines that the vehicle can pass through the crosswalk and the vehicle passes through the crosswalk, the angle of the vehicle changes and the crosswalk is no longer reflected in the image in the lateral direction captured by the right-side camera 12. When it is detected in step S37 that the crosswalk is no longer reflected in the image in the lateral direction, the process proceeds to step S38.

In step S38, the CPU of the display system 100 returns to the default state in FIG. 4 displaying an image that is wide in the lateral direction with the lower portion of the vehicle as the center (display state during normal traveling) in the second display region D2 of the right monitor 14 and the left monitor 15.

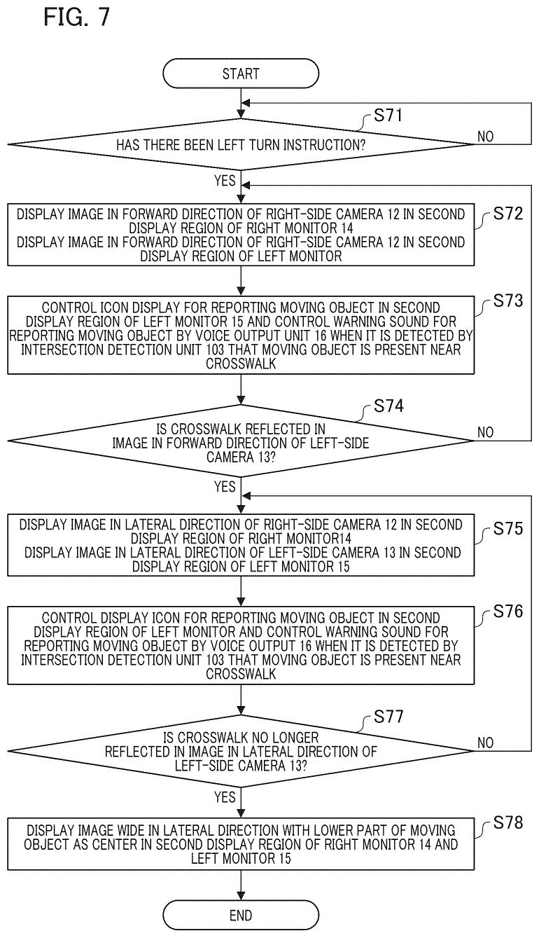

Next, FIG. 7 is a flowchart illustrating an example of the processing flow during a left turn that the display system 100 in the embodiment of the present invention executes. Note that the operation of each step in the flowchart of FIG. 7 is performed by the CPU serving as a computer in the display system 100 executing a computer program stored in the memory.

In step S71, the CPU of the display system 100 determines whether or not a left turn instruction has been issued. If “NO” is determined, the process returns to step S71. When the driver of the vehicle 2 tilts the blinker to the left with the blinker operation unit 11, the right/left turn detection unit 101 determines that a left turn instruction has been issued in step S71, and the process proceeds to step S72.

Next, in step S72, the CPU of the display system 100 causes the monitor control unit 104 to display an image in the forward direction captured by the right-side camera 12 in the second display region D2 of the left monitor 15.

Additionally, the image in the forward direction captured by the right-side camera 12 is also displayed in the second display region D2 of the right monitor 14. That is, in the present embodiment, even in a left turn ready state of the vehicle 2 (the state in which the left blinker is operated), the image in at least the forward direction captured by the right-side camera 12 is displayed on the monitor (left monitor).

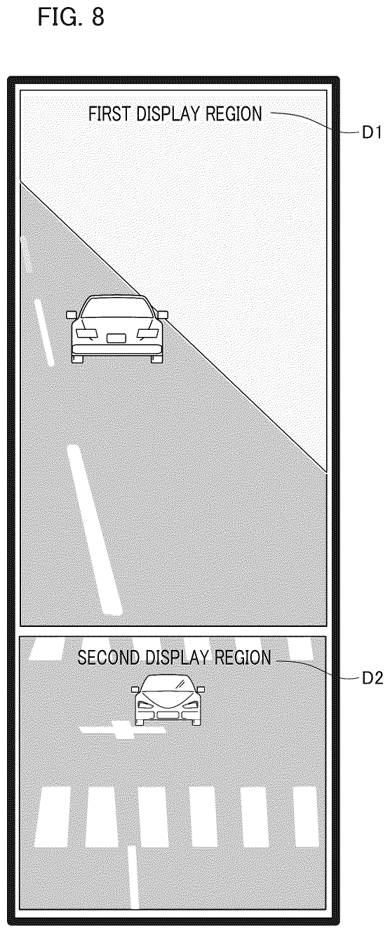

FIG. 8 is a diagram showing an example of an image of an opposite lane displayed on the right monitor 14 while waiting for a left turn in the embodiment of the present invention. The image displayed in the second display region D2 of FIG. 8 is an image in the forward direction captured by the right-side camera 12, and is a scene in which a vehicle waiting for a right turn is present in the opposite lane. At this time, the image in the forward direction captured by the right-side camera 12 is also displayed in the second display region D2 of the left monitor 15.

The vehicle stops near the intersection to wait for a left turn, and the driver visually checks whether or not a motorcycle, a bicycle, and the like come from the left backward direction. In this scene, it is typical for drivers not to care much about vehicles turning right from the opposite lane.

However, there are cases in which, at the moment when the traffic light changes from red to green at the intersection, a vehicle turning left and a vehicle turning right may simultaneously enter the crosswalk on the left side to cause a collision accident. Accordingly, in the present embodiment, the image in the forward direction captured by the right-side camera 12 as shown in FIG. 8 is displayed in the second display region D2 of the left monitor 15 that is within the driver's field of view, so that the driver can easily recognize a vehicle turning right in the opposite lane turns ahead.

In addition, although not illustrated in the flowchart, control may be performed in which the monitor icon control unit 105 causes the left monitor 15 to display an icon indicating that a right turn vehicle in the opposite lane has turned, or the sound warning control unit 106 causes the voice output unit 16 to output a warning sound informing that a right-turn vehicle in the opposite lane has turned. By performing such a control, the driver can more reliably recognize that a right turn vehicle in the opposite lane is turning.

Next, in step S73, the CPU of the display system 100 detects, in the intersection detection unit 103, whether or not a moving object is present in the crosswalk. First, since the vehicle stops in front of the intersection, the image in the lateral direction of the left-side camera 13 is obtained from the image processing buffer unit 102. Next, it is detected by image recognition whether or not a moving object is reflected around the crosswalk and the like by using the same method as in step S33.

When a moving object is detected, control is performed from the monitor icon control unit 105 to report the presence of a moving object with an icon in the second display region D2 of the left monitor 15. Additionally, control is performed from the sound warning control unit 106 to output a warning sound informing about the presence of a moving object to the sound output unit 16.

As described above, the driver is informed that a moving object is present around the crosswalk, and even if a motorcycle or bicycle from the left backward is not present, the driver can be informed that a left turn is not yet possible. Therefore, it is possible to prevent an accident, for example, around a crosswalk on the front side during a left turn. In contrast, when the moving object is not detected, the process proceeds to the next step S74.

In step S74, the CPU of the display system 100 detects, in the intersection detection unit 103, whether or not a crosswalk is reflected in the image in the forward direction of the left-side camera 13. That is, when the driver determines that he/she can turn left and starts to turn left, the angle of the vehicle changes and the crosswalk is reflected in the image in the forward direction of the left side camera 13.

Specifically, an image in the forward direction of the left-side camera 13 is obtained from the image processing buffer unit 102, and it is detected that the crosswalk is reflected by using the above-described method. While the crosswalk is not reflected in the image in the forward direction, the process returns to step S72, and the current display is maintained.

In contrast, in step S74, when it is detected that the crosswalk is reflected in the image in the forward direction of the left-side camera 13 (the crosswalk is detected), the process proceeds to step S75. In step S75, the CPU of the display system 100 displays an image in the lateral direction of the left-side camera 13 in the second display region D2 of the left monitor 15, as shown in FIG. 6.

That is, when the vehicle 2 starts a left turn and a crosswalk is detected, an image in at least the lateral direction of the vehicle 2 captured by at least the left-side camera 13 is displayed on the monitor. Similarly, although not illustrated, an image in the lateral direction captured by the right-side camera 12 is also displayed in the second display region D2 of the right monitor 14.

The image displayed in the second display region D2 in FIG. 6 is an image in the case in which the vehicle is around the front of the crosswalk. In general, in the case of a left turn, the moving object coming from the right of the crosswalk as viewed from the vehicle is on the line of sight, making it easy for the driver to check visually. In contrast, as in the image displayed in the second display region D2 in FIG. 6, the moving object coming from the left of the crosswalk as viewed from the vehicle deviates from the line of sight, resulting in a delay in noticing.

However, in the present embodiment, it is possible to easily check a moving object coming from the left side around the crosswalk, such as a bicycle and a person running by displaying the image in the lateral direction of the left-side camera 13 in the second display region D2 of the left monitor 15. Therefore, it is possible to prevent an accident around the crosswalk during a left turn.

Next, in step S76, as in step S73, when a moving object is present around the crosswalk, the CPU of the display system 100 notifies the driver of the presence of the moving object by displaying an icon or emitting a warning sound. Thus, an accident around the crosswalk during a left turn can be more reliably prevented.

Then, in step S77, the CPU of the display system 100 causes the intersection detection unit 103 to detect whether or not the crosswalk is no longer reflected in the image in the lateral direction of the left-side camera 13.

Specifically, the image in the lateral direction of the left-side camera 13 is obtained from the image processing buffer unit 102, and it is detected whether or not the crosswalk is not reflected by the above-described method. While the crosswalk is reflected in the image in the lateral direction, the process returns to step S75, and the current display is maintained.

When the driver determines that the vehicle can pass through the crosswalk and the vehicle passes through the crosswalk, the angle of the vehicle changes and the crosswalk is no longer reflected in the image in the lateral direction of the left-side camera 13. As a result, when it is determined in step S77 that the crosswalk no longer reflected in the image in the lateral direction of the left-side camera 13, the process proceeds to step S78.

In step S78, the CPU of the display system 100 returns to displaying the default state in FIG. 4 displaying an image that is wide in the lateral direction with the lower portion of the vehicle 2 as the center (display of normal traveling state) in the second display region D2 of the right monitor 14 and the left monitor 15.

As described above, the images displayed in the second display regions D2 of the right monitor 14 and the left monitor 15 are switched according to whether the vehicle during a right or left turn is waiting for a right or left turn or is in the middle of a right or left turn, and as a result, it is possible to more quickly notify the driver of danger around the vehicle, and to prevent accidents.

Although the right monitor 14 and the left monitor 15 are divided into two in the present embodiment, they may be divided into three or more as described above. That is, in the present embodiment, since the display screen of the monitor is divided to simultaneously display a plurality of images, it is not necessary to switch the screen one by one. Additionally, for example, in the first display region D1, an image similar to an optical side mirror may be displayed, in the second display region D2, an image in the forward direction may be displayed, and in the third display region, an image in the lateral direction may be displayed.

In this case, the sizes of the second and third display regions may be increased or decreased according to a scene of a right or left turn, so that the driver can easily recognize the presence of a moving object in the vicinity. That is, in the state in which the vehicle is ready to turn right or left, the size of an image in at least the forward direction captured by the right-side camera may be displayed larger than that during normal travelling.

Additionally, when the vehicle starts to turn right or left and a crosswalk is detected, each of images in the lateral direction of the vehicle captured by at least the right or left side camera may be displayed larger than that during normal traveling. In this case, since the displayed image is not switched, the driver can easily recognize the image without a sense of discomfort.

Note that, although, in the explanation of the above embodiment, the traveling lane of the vehicle 2 is explained as the right side as the above embodiment is based on rules of left-hand traffic, in a case of a system based on rules of right-hand traffic, the traveling lane is the left side, and the left and right in the explanation of the above embodiment should read reversely.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the display system through a network or various storage media. Then, a computer (or a CPU, an MPU, and the like) of the display system may be configured to read and execute the program. In such a case, the program and the storage medium storing the program configure the present invention.

Additionally, the present invention includes, for example, one realized using at least one processor or circuit mechanism to function of the embodiments above. Note that, distributed processing may be performed using multiple processors.

This application claims the benefit of Japanese Patent Application No. 2022-163774, filed on Oct. 12, 2022, which is hereby incorporated by reference herein in its entirety.

1. A display system comprising:
an opposite lane side camera that is positioned on an opposite lane side of a vehicle and is capable of capturing an image in at least a forward direction of the vehicle; and
at least one processor or circuit configured to function as a monitor control unit configured to cause a monitor to display the image in at least the forward direction captured by the opposite lane side camera when the vehicle is in an opposite lane side turn ready state.

2. The display system according to claim 1, wherein the monitor includes an opposite lane side monitor positioned on an opposite lane side of the vehicle, and
wherein the monitor control unit causes the opposite lane side monitor to display the image in at least the forward direction captured by the opposite lane side camera when the vehicle is in the opposite lane side turn ready state.

3. The display system according to claim 1, wherein the monitor control unit causes the monitor to display the image in at least the forward direction captured by the opposite lane side camera when the vehicle is in a non-opposite lane side turn ready state.

4. The display system according to claim 3, wherein the monitor includes a non-opposite lane side monitor positioned on a non-opposite lane side of the vehicle, and
wherein the monitor control unit causes the non-opposite lane side monitor to display the image in at least the forward direction captured by the opposite lane side-side camera when the vehicle is in the non-opposite lane side turn ready state.

5. The display system according to claim 1, wherein, in a case in which the vehicle starts an opposite lane side turn and a crosswalk is detected, the monitor control unit causes the monitor to display an image in a lateral direction of the vehicle captured by at least the opposite lane side camera.

6. The display system according to claim 1 further comprising a non-opposite lane side camera positioned on a non-opposite lane side of the vehicle and capable of imaging at least a lateral direction of the vehicle.

7. The display system according to claim 6, wherein, in a case in which the vehicle starts a non-opposite lane side turn and a crosswalk is detected, the monitor control unit causes the monitor to display an image in at least a lateral direction of the vehicle captured by at least the non-opposite lane side camera.

8. The display system according to claim 1, wherein the monitor control unit divides a display screen of the monitor to simultaneously display a plurality of images.

9. The display system according to claim 1, wherein the opposite lane side turn ready state is determined based on an opposite lane side blinker operation of the vehicle.

10. The display system according to claim 1, wherein the at least one processor or circuit is further configured to function as a notification unit configured to provide a notification in a case in which a moving object is detected based on the image.

11. The display system according to claim 1, wherein the opposite lane side camera has an optical system and an imaging element configured to capture an optical image formed on a light-receiving surface by the optical system.

12. The display system according to claim 11, wherein the optical system forms a high-resolution region in a peripheral portion of the light receiving surface and forms a low-resolution region in a central portion of the light receiving surface.

13. The display system according to claim 12, wherein an image in the forward direction is an image corresponding to the high-resolution region.

14. The display system according to claim 11, wherein, where f is a focal length of the optical system, θ is a half angle of view, y is an image height on an image plane, y (θ) is a projection characteristic representing a relation between the image height y and the half angle of view θ, and θ max is the maximum half angle of view of the optical system, then 0.2<2×f×tan (θ max/2)/y (θ max)<0.92 is satisfied.

15. A vehicle comprising:
an opposite lane side camera that is positioned on an opposite lane side of the vehicle and capable of capturing an image in at least a forward direction of the vehicle;
a monitor; and
a monitor control unit configured to cause the monitor to display an image in at least the forward direction captured by the opposite lane side camera when the vehicle is in an opposite lane side turn ready state.

16. A control method of a display system having an opposite lane side camera that is disposed on an opposite lane side of a vehicle and capable of capturing an image in at least a forward direction of the vehicle, the control method comprising:
performing monitor control that causes a monitor to display the image in at least the forward direction captured by the opposite lane side camera when the vehicle in an opposite lane side turn ready state.

17. A non-transitory computer-readable storage medium configured to store a computer program comprising instructions for executing following process:
capturing, by an opposite lane side camera that is positioned on an opposite lane side of a vehicle, an image in at least a forward direction of the vehicle; and
performing monitor control that causes a monitor to display the image in at least the forward direction captured by the opposite lane side camera when the vehicle is in an opposite lane side turn ready state.
